(19) United States
(12) Patent Application Publication
(10) Pub. No.: US 2013/0233484 A1
(43) Pub. Date: Sep. 12, 2013

(54) Process of Laminating Border For Bedding Product Without Heat

(71) Applicant: L&P PROPERTY MANAGEMENT COMPANY, South Gate, CA (US)

(72) Inventor: Terrance L. Myers, Joplin, MO (US)

(73) Assignee: L&P PROPERTY MANAGEMENT COMPANY, South Gate, CA (US)

(21) Appl. No.: 13/783,905

(22) Filed: Mar. 4, 2013

Related U.S. Application Data
(60) Provisional application No. 61/609,545, filed on Mar. 12, 2012.

(51) Int. Cl. B32B 37/12

(52) U.S. Cl. CPC B32B 37/1284
USPC 156/306.6; 156/60

(57) ABSTRACT

A method of making a multi-layer border for use in a bedding product, such as a mattress, is disclosed. The layers are secured together without the use of heat, thereby enabling the process to be stopped and started as desired without the worry of burning the materials. Pressure is applied to the multi-layered material in the form of pinch rollers to secure the layers together. One of the layers comprises an outer ticking material. As many layers of foam and/or fiber as desired may be included, provided a layer of doubled-sided adhesive is sandwiched between adjacent layers. A backing may comprise the innermost layer.

### CROSS-REFERENCE TO RELATED APPLICATIONS

This application claims the benefit of the filing of U.S. Provisional Patent Application Ser. No. 61/609,545 filed Mar. 12, 2012 entitled “Process of Laminating Border For Bedding Product Without Heat”, which is fully incorporated by reference herein.

### TECHNICAL FIELD

The present invention relates generally to borders for bedding and seating products, and the methods for making such products.

### BACKGROUND

Materials for use in bedding or seating products have been manufactured by combining multiple different layers of material and sewing or quilting them together. It is known to use a slitter in combination with a quilting machine to make a quilted product a desired width or size. One product, known as a border and used in the manufacture of a bedding product, has been produced in this manner. The thread used in the quilting process combines the layers together so they do not separate.

In the bedding industry, it is known to combine a ticking or outer layer with a layer of fiber or foam using a heated or hot melt adhesive. The adhesive is applied between the ticking layer and the layer of fiber or foam and then it all is passed through a heated “calendar” drum. One of the difficulties with using this method to combine multiple layers is that once the process starts, it cannot be stopped. If the process is stopped, the portion of the product inside the heated drum section becomes damaged or burnt. Another difficulty with using this method to combine multiple layers is that the temperature necessary to melt the adhesive (between 167 and 392 degrees Fahrenheit) can create material handling issues.

Thus, a need exists in the art for a “cold” method of creating a multi-layered material used to make a border for a bedding product which does not use heat. There is further a need for a method which may be stopped and started while processing material without damaging the material.

### SUMMARY OF THE INVENTION

According to one aspect of the invention, a method of producing a laminated border for a mattress comprises the following steps. First, a ticking layer unrolled from a roll of ticking material and at least one layer of foam or fiber is provided. The ticking layer is secured to the at least one layer of foam or fiber with a layer of adhesive without using heat to create a multi-layered web. The multi-layered web may be any number of layers. A layer of adhesive is sandwiched between two adjacent layers regardless of the type of material. The multi-layered web may have a backing.

The layer of adhesive is unrolled from a roll of backed adhesive. For purposes of this document, backed adhesive comprises a layer of double-sided adhesive, one side being adhered to a backing layer. After the backed adhesive layer is unrolled and the layer of adhesive applied to a layer of ticking or foam or fiber or backing, the backing of the backing adhesive is wound up to be discarded.

According to another aspect of the invention, the adhesive may be sprayed onto one or more of the layers of material before the materials are pressed together without the use of heat.

According to another aspect of the invention, a slitter attachment may be added onto the apparatus which performs the methods disclosed herein. The slitter attachment slits the multi-layered web to a desired width.

### BRIEF DESCRIPTION OF THE DRAWINGS

The accompanying drawings, which are incorporated in and constitute a part of this specification, illustrate embodiments of the invention and, together with the general description given above and the detailed description of the embodiments given below, serve to explain the principles of the invention. In the figures, corresponding or like numbers or characters indicate corresponding or like structures.

FIG. 1 is a partially disassembled perspective view of a casing adapted to receive a spring or foam core therein.

FIG. 1A is a cross-sectional view taken along line 1A-1A of FIG. 1.

FIG. 2 is a diagrammatic side view of an apparatus adapted to perform at least some of the methods of the present invention.

FIG. 2A is a diagrammatic side cross-sectional view of area 2A of FIG. 2.

FIG. 3 is a disassembled perspective view of one embodiment of border made in accordance with the present invention.

FIG. 4 is a disassembled perspective view of another embodiment of border made in accordance with the present invention.

FIG. 5 is a diagrammatic perspective view of an apparatus adapted to perform at least some of the methods of the present invention.

FIG. 6 is a diagrammatic perspective view of another apparatus adapted to perform at least some of the methods of the present invention.

### DETAILED DESCRIPTION OF THE ILLUSTRATIVE EMBODIMENTS

Referring to the figures, a casing adapted to receive and retain an insert (not shown), such as a spring core or foam core or any combination thereof, is generally indicated by the numeral 10. The casing 10 includes a bottom 12, a top 14 and a sidewall or border 16 having a flange 18 extending inwardly from an upper edge of the border 16. Many features of the apparatus and method described herein are discussed in the context of making a border for a mattress, but may be used to make other portions of bedding or seating products.

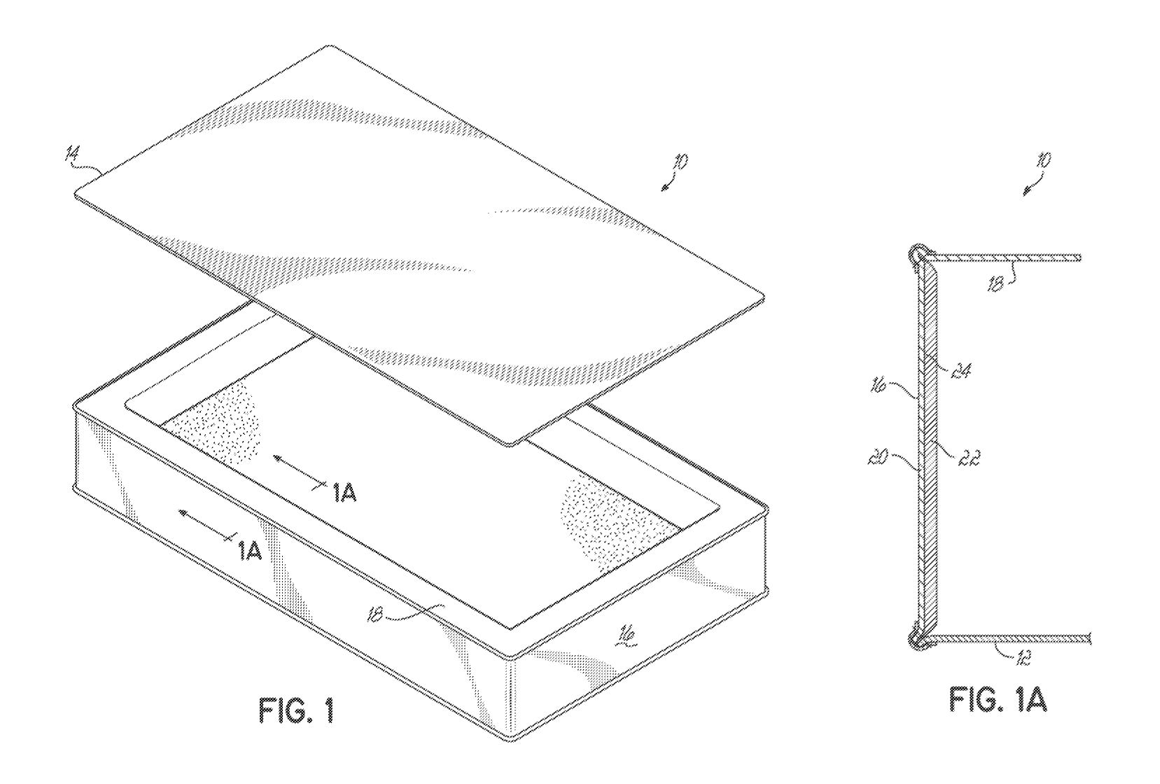

As shown in FIG. 1A, the border 16 comprises an outer layer of ticking 20 and an inner layer of foam or fiber 22 secured together with a layer of double-sided adhesive 24. The double-sided adhesive 24 enables the two layers 20, 22 to be connected together without the use of sewing or heating. Pressure applied to the layers in a manner described below from rollers is enough to secure the layers into a unitary product which will not separate into its individual layers under normal wear conditions.

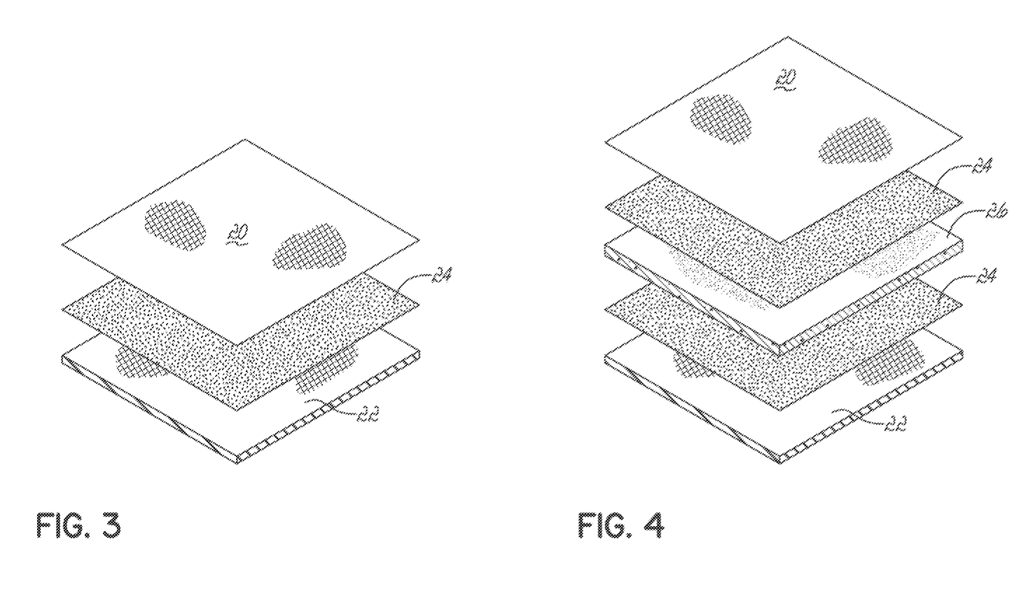

FIG. 3 illustrates the outer ticking layer 20 separated from the adhesive layer 24 and separated from the layer 22 of fiber. The thickness and size of these layers shown in the drawings is for illustrative purposes only and is not intended to be limiting.

FIG. 4 shows an outer ticking layer 20 spaced above a layer of double-sided adhesive 24 spaced above a layer of foam 26 spaced above a layer of double-sided adhesive 24 spaced above a layer of fiber 22. The thickness and size of these layers shown in the drawings is for illustrative purposes only and is not intended to be limiting. Although the drawings show specific numbers of layers, the present invention is not intended to be limited to any number of layers of ticking, fiber or foam or backing layers. Between adjacent layers of foam and fiber resides a layer of double-sided adhesive 24, regardless of the number of layers.

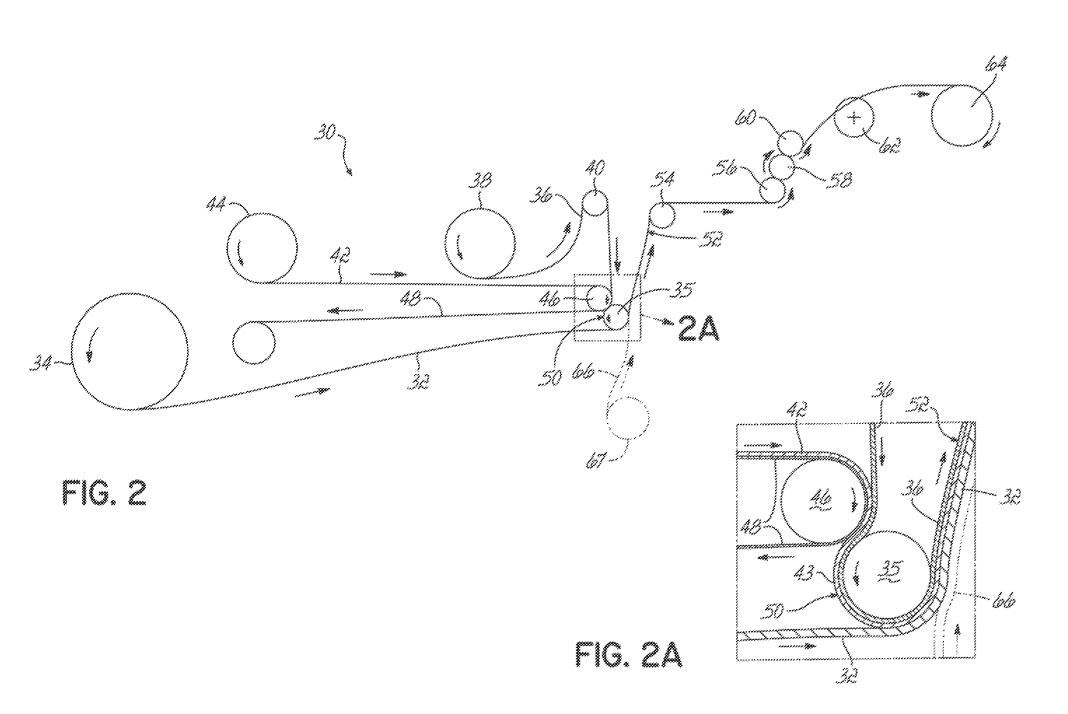

FIG. 2 illustrates an apparatus 30 for use with a quilter. The apparatus comprises a plurality of rollers used to make a multi-layered or laminated product for a mattress or box spring or any bedding or seating product without using heat. The method of making the laminated product includes the following steps.

As shown in FIGS. 2 and 2A, a layer of foam or fiber material 32 is unrolled from a roll 34 of foam or fiber and passed underneath a roller 35. A layer of ticking material 36 is similarly unrolled from a roll of ticking material 38 and passed over a roller 40. A layer of backed adhesive 42 is unwound from a roll 44 of backed adhesive and passed around roller 46. The layer of backed adhesive 42 comprises a layer of backing 48 and a layer of double-sided adhesive 43 secured together. At roller 46, the layer of double-sided adhesive 43 separates from the layer of backing 48 and adheres to one side of the layer of ticking material 36. The resulting multi-layered web 50 comprising a layer of ticking 36 and a layer of double-sided adhesive 43 passes around roller 35 (down the left side of roller 35 as shown in FIGS. 2 and 2A) where the adhesive layer 43 of the multi-layered web 50 attaches to one side of the layer of foam or fiber material 32. The multi-layered web 52, extending further around roller 35 and comprising three layers, a layer of foam/fiber, a layer of adhesive and a layer of ticking, is passed around roller 54.

The multi-layered web 52 is then passed between three pinch rollers 56, 58 and 60 which apply pressure to combine the layers of the multi-layered web 52 into a unitary sheet or web which may pass through a border slitter attachment 62. The border slitter attachment 62 comprises one or more blades which may be adjusted to cut the multi-layered web 52 to any desired width. Lastly, the multi-layered web 52 may be rolled up into a finished roll or rolls 64.

If desired, the multi-layered web 52 may include one or more backing layers 66 unrolled from a roll 67, shown in phantom in FIGS. 2 and 2A.

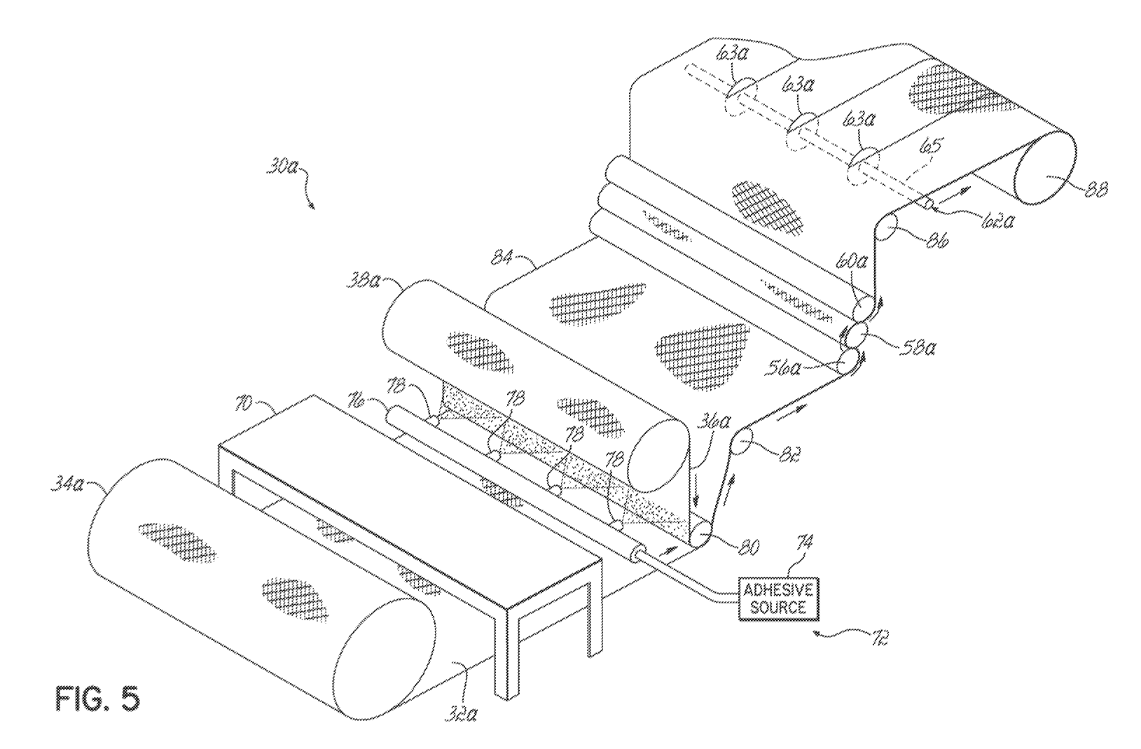

FIG. 5 illustrates another apparatus 30a for use with a quilter. For simplicity, like numbers denote like parts, but with an “a” after the number. The apparatus 30a comprises a plurality of rollers used to make a multi-layered or laminated product for a mattress or box spring or any bedding or seating product without using heat. The method of making the laminated product includes the following steps.

As shown in FIG. 5, a layer of foam or fiber material 32a is unrolled from a roll 34a of foam or fiber and passed underneath a catwalk 70. A layer of ticking material 36a is similarly unrolled from a roll 38a of ticking material. A sprayer 72, comprising a source 74 of adhesive and a spray tube 76 having a plurality of nozzles 78, is used to spray adhesive onto one side of the ticking material 36a. A multi-layered combined web 84, comprising the layer of foam or fiber 34a and the layer of ticking material 36a, the sprayed layer of adhesive therebetween, is passed under a roller 80 and over another roller 82. The resulting multi-layered web 84, comprising a layer of ticking 36a, a layer of adhesive and a layer of foam or fiber 32a, is then passed between three pinch rollers 56a, 58a and 60a, which apply pressure to combine the layers of the multi-layered web 84 into a unitary sheet or web, which may then pass over a roller 86 and through a border slitter attachment 62a. The border slitter attachment 62a comprises multiple blades 63a mounted on a shaft 65. The blades 63a may be adjusted to cut the multi-layered web 84 to any number of pieces of any desired width. Lastly, the multi-layered web 84 may be rolled up into a finished roll or rolls 88.

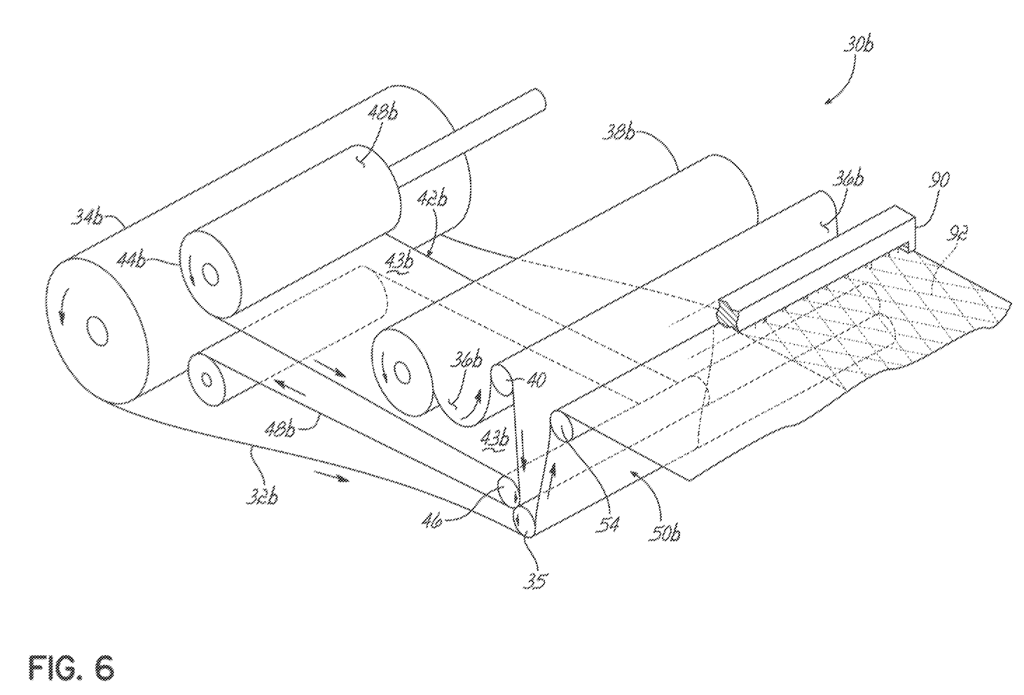

FIG. 6 illustrates another apparatus 30b for use with a quilter. For simplicity, like numbers denote like parts, but with a letter “b” after the number. The apparatus 30b comprises a plurality of rollers used to make a multi-layered or laminated product for a mattress or box spring or any bedding or seating product without using heat. The method of making the laminated product includes the following steps.

As shown in FIG. 6, a layer of foam or fiber material 32b is unrolled from a roll 34b of foam or fiber and passed underneath a roller 35. A layer of ticking material 36b is similarly unrolled from a roll 38b of ticking material and passed over a roller 40. A layer of backed adhesive 42b is unwound from a roll 44b of backed adhesive and passed around roller 46. The web or layer of backed adhesive 42b comprises a backing 48b, which extends the full width of the web 42b and a layer of double-sided adhesive 43b, which extends less than the full width of the web of backed adhesive 42b. At roller 46, the layer of double-sided adhesive 43b separates from the layer of backing 48b and adheres to one side of the layer of ticking material 36b. The resulting multi-layered web 50b, comprising a layer of ticking 36b and a layer of double-sided adhesive 43b, passes around roller 35 (down the left side of roller 35 as shown in FIG. 6) where the adhesive of the multi-layered web 50b attaches to one side of the layer of foam or fiber material 32b. The multi-layered web 50b, extending further around roller 35 and comprising three layers, a layer of foam/fiber, a layer of adhesive and a layer of ticking, is passed around roller 54.

After passing roller 54, a quilter 90 sews the layer of foam/fiber 32b and the layer of ticking 36b together without any adhesive. This happens only on the right side of the multi-layered web 50b in a pattern 92. Although the pattern shown comprises diamonds, any desired quilted pattern may be incorporated into a multi-layered web. On the other side, the left side as shown in FIG. 6, the multi-layered web 50b comprises the layer of foam/fiber 32b, a layer of adhesive 43b and the layer of ticking 36b.

The multi-layered web 50b may then pass between pinch rollers, as shown in FIG. 2, which apply pressure to combine the layers of the multi-layered web 50b into a unitary sheet or web, which may pass through a border slitter attachment like the one shown in FIG. 2. Lastly, the multi-layered web 50b may be rolled up into a finished roll or rolls as shown in FIG. 2.

While the invention has been illustrated by the description of embodiments thereof, and while the embodiments have been described in considerable detail, it is not intended to restrict, or in any way limit, the scope of the appended claims to such detail. Additional advantages and modifications will readily appear to those skilled in the art. Therefore, the invention in its broadest aspects is not limited to the specific details shown and described. The various features disclosed herein may be used in any combination necessary or desired for a particular application. Consequently, departures may be made from the details described herein without departing from the spirit and scope of the claims which follow.

What is claimed is:

1. A method of producing a laminated border for a mattress, the method comprising:
providing a ticking layer unrolled from a roll of ticking material;
providing at least one layer of foam or fiber;
wherein the ticking layer is secured to the at least one layer of foam or fiber with a layer of adhesive without using heat to create a multi-layered web.

2. The method of claim 1, wherein the layer of adhesive is sprayed onto the ticking layer.

3. The method of claim 1, wherein the layer of adhesive is unrolled from a roll of backed adhesive.

4. The method of claim 3, wherein the layer of adhesive is removed from a backing.

5. The method of claim 4, wherein the backing is collected on a wind-up roll.

6. The method of claim 1, wherein the multi-layered web is compressed together with pinch rollers.

7. The method of claim 2, wherein the multi-layered web is compressed together with pinch rollers.

8. The method of claim 3, wherein the multi-layered web is compressed together with pinch rollers.

9. The method of claim 4, wherein the multi-layered web is compressed together with pinch rollers.

10. The method of claim 1, further comprising slitting the multi-layered web with a slitter attachment.

11. A method of producing a laminated border for a mattress, the method comprising:
providing a roll of ticking material;
providing a roll of foam material;
providing a roll of backed adhesive comprising a layer of adhesive material being secured to a backing;
unrolling the ticking material;
separating the backing from the adhesive material;
securing the adhesive material to the ticking material to create a sticky ticking material;
securing a layer of foam unrolled from the roll of foam to the adhesive material to create a multi-layered web without heating any of the materials.

12. The method of claim 11, further comprising providing at least one roll of fiber material.

13. The method of claim 12, further comprising unrolling the roll of fiber material and securing it to the layer of foam via another layer of adhesive material.

14. The method of claim 11, wherein the adhesive material is sticky on both sides.

15. The method of claim 11, wherein the backing is collected on a wind-up roll.

16. The method of claim 11, wherein the multi-layered web is compressed together with pinch rollers.

17. The method of claim 11, further comprising slitting the multi-layered web with a slitter attachment.

18. A method of producing a laminated border for a mattress, the method comprising:
unrolling ticking material from a roll of ticking material;
unrolling fiber material from a roll of fiber material;
unrolling a roll of backed adhesive from a roll of backed adhesive, the backed adhesive comprising a layer of adhesive material secured to a backing;
separating the backing from the adhesive material;
securing the adhesive material to the ticking material;
securing a layer of fiber unrolled from the roll of fiber to the adhesive material to create a multi-layered web without heating any of the materials.

19. The method of claim 18, further comprising providing a roll of foam material.

20. The method of claim 19, further comprising unrolling the roll of fiber material and securing it to the layer of foam via another layer of adhesive material.

21. The method of claim 18, wherein the adhesive material is sticky on both sides.

22. The method of claim 18, wherein the backing is collected on a wind-up roll.

23. The method of claim 18, wherein the multi-layered web is compressed together with pinch rollers.

24. The method of claim 18, further comprising slitting the multi-layered web with a slitter attachment.
